(19) United States
(12) Patent Application Publication
(10) Pub. No.: US 2005/0086638 A1
(43) Pub. Date: Apr. 21, 2005

(54) Method and system for editing column oriented programming language statements

(75) Inventor: Brian Farn, Toronto (CA)

Correspondence Address: Diana L. Roberts;International Business Machines, Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/782,498

(22) Filed: Feb. 19, 2004

(30) Foreign Application Priority Data
Oct. 17, 2003 (CA) 2,445,427

(51) Int. Cl. G06F 9/44

(52) U.S. Cl. 717/113; 717/111; 717/106; 717/110; 717/114; 717/105

(57) ABSTRACT

For a program statement editor, a method for editing column oriented programming language statements presented to a user on a display screen, comprising: providing a template description defining one or more statement types; and, providing a graphical user interface (“GUI”) for editing the statements individually, the GUI having one or more editable fields corresponding to a statement type of an individual statement defined by the template description, the GUI adapted to receive content for one or more of the editable fields from the user to define the individual statement.

### FIELD OF THE INVENTION

This invention relates to the field of computer program editing tools, and more specifically, to editing tools for column oriented programming language statements.

### BACKGROUND

Computer program editors are specialized editors that allow computer programmers to create and modify computer programs. In addition to supporting basic word processing functions such as block copy/move and string find/replace, most computer program editors provide additional editing features that are valuable to the programmer. Such additional features may include highlighting important structural constructs (e.g., condition statements, keywords, brackets, etc.) and providing language-sensitive commands for navigating, modifying, and reformatting programs. In addition, program editors typically assist programmers with statement syntax and object identification, etc.

One form of computer program editor is the line editor. Line editors for programming languages such as Report Program Generator (“RPG”) and Data Description Specification (“DDS”) are available from the International Business Machines Corporation (“IBM”). In general, line editors are used for editing column based or oriented programming language statements. Typically, each such programming language statement occupies a single editable line (e.g., 80 columns or characters in length). In addition, each programming statement type has a fixed format consisting of one or more fields, where each field begins at a fixed column number and occupies a specific number of contiguous columns.

One disadvantage of present line editors is that the view of the program statements (i.e., the editor view) that these editors present to a programmer often includes a large selection or all of the program's statements. That is, the editor view is scoped to all of a program's statements. This is problematic as it reduces the programmer's efficiency when composing single fixed format statements.

A need therefore exists for an improved program editor for column oriented programming language statements. Accordingly, a solution that addresses, at least in part, the above and other shortcomings is desired.

### SUMMARY

According to one aspect of the invention there is provided, for a program statement editor, a method for editing column oriented programming language statements presented to a user on a display screen, comprising: providing a template description defining one or more statement types; and, providing a graphical user interface (“GUI”) for editing the statements individually, the GUI having one or more editable fields corresponding to a statement type of an individual statement defined by the template description, the GUI adapted to receive content for one or more of the editable fields from the user to define the individual statement.

Preferably, the method further includes permitting the individual statement to be selected by the user for replacement from among the statements.

Preferably, the method further includes permitting a position in the statements to be selected by the user for insertion of the individual statement.

Preferably, the method further includes displaying a field difference indicator on the GUI for each of the editable fields whose contents has been changed by the user.

Preferably, the method further includes selectively replacing or inserting the individual statement in the statements.

Preferably, the method further includes displaying a user selectable apply button on the GUI for initiating the replacing and inserting.

Preferably, the template description is an extensible mark-up language (“XML”) document.

In accordance with further aspects of the present invention there is provided an apparatus such as data processing system, personal computer or server system, a method for adapting these systems, as well as articles of manufacture such as a computer readable medium having program instructions recorded thereon for practising the method of the invention.

Advantageously, the present invention allows a programmer to focus editing efforts on a single column oriented programming statement included in a group of such statements.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating an exemplary data processing system adapted for implementing an embodiment of the invention;

FIG. 2 is a screen capture illustrating a GUI for line editing having an editor view and a source prompter view in accordance with an embodiment of the invention;

FIG. 3 is a partial screen capture illustrating hover text for the source prompter view of FIG. 2 in accordance with an embodiment of the invention;

FIG. 4 is an exemplary XML document illustrating page group information in accordance with an embodiment of the invention;

FIG. 5 is a chart illustrating the composition of a new statement from an original statement and a template string in accordance with an embodiment of the invention; and,

FIG. 6 is a flow chart illustrating operations of modules within a data processing system for editing column oriented programming language statements presented to a user on a computer display screen in accordance with an embodiment of the invention.

It will be noted that throughout the appended drawings, like features are identified by like reference numerals.

### DETAILED DESCRIPTION OF THE PREFERRED EMBODIMENTS

The following detailed description of the embodiments of the present invention does not limit the implementation of the invention to any particular computer programming language. The present invention may be implemented in any computer programming language provided that the operating system (“OS”) provides the facilities that may support the requirements of the present invention. A preferred embodiment is implemented in the JAVA™ computer programming language (or other computer programming languages such as C or C++). (JAVA and all JAVA-based trademarks are the trademarks of Sun Microsystems Corporation.) Any limitations presented would be a result of a particular type of operating system or computer programming language and would not be a limitation of the present invention.

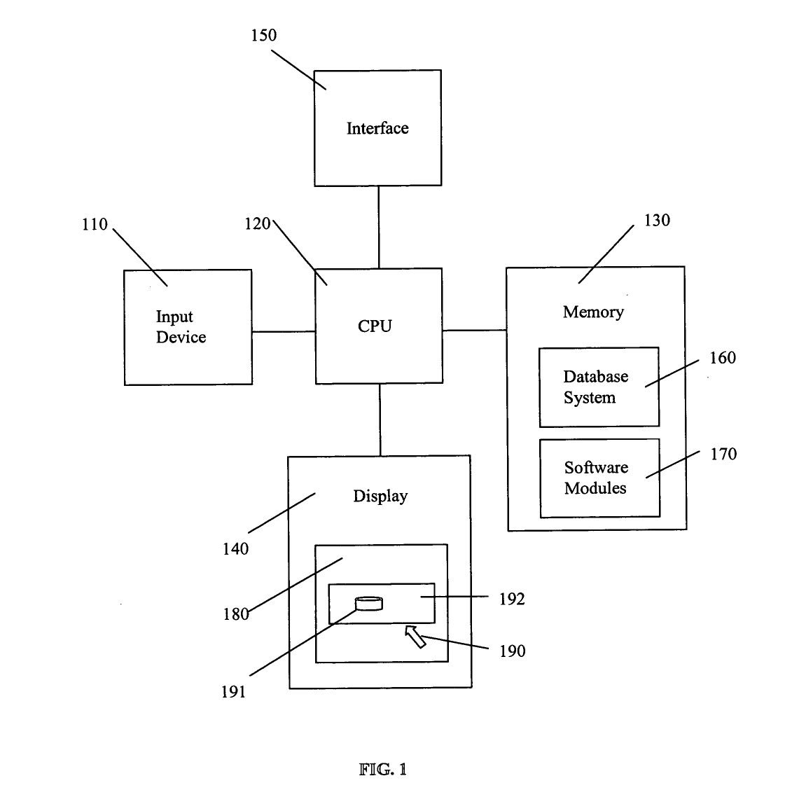

FIG. 1 is a block diagram illustrating an exemplary data processing system 100 adapted for implementing an embodiment of the invention. The data processing system 100 includes an input device 110, a central processing unit or CPU 120, memory 130, a display 140, and an interface 150. The input device 110 may include a keyboard, mouse, trackball, remote control, or similar device. The CPU 120 may include dedicated coprocessors and memory devices. The memory 130 may include RAM, ROM, or disk devices. The display 140 may include a computer screen, terminal device, or a hardcopy producing output device such as a printer or plotter. And, the interface 150 may include a network connection including an Internet connection. The data processing system 100 is adapted to perform program editing in accordance with the present invention.

The data processing system 100 may be a server system or a personal computer system. The CPU 120 of the data processing system 100 is operatively coupled to memory 130 which stores an operating system (not shown) for general management of the system 100. The interface 150 may be used for communicating to external data processing systems (not shown) through a network (not shown), such as the Internet. Examples of suitable data processing systems 100 include IBM iSeries™ servers and ThinkPad™ personal computers.

The data processing system 100 may include a database system 160 for storing and accessing programming information. The database system 160 may include a database management system (“DBMS”) and a database and is stored in the memory 130 of the data processing system 100. It will be appreciated that the database system 160 may be shipped or installed without the database to or by end users. In general, the DBMS is adapted to read a query generated by the data processing system 100 in response to a request for information submitted by a user typically through a user interface. The DBMS then executes the query against the database and provides a query result to the data processing system 100 for presentation to the user. It will be appreciated that the database system 160 may be stored in the memory 130 of the data processing system 100 or stored in a distributed data processing system (not shown).

An example of a suitable DBMS is the DB2™ Universal Database Management System product available from IBM. The DBMS is a software layer interposed between the actual database (i.e. the data as stored for use by the CPU 120 of the system 100) and the users of the system. The DBMS is responsible for handling database transactions thus shielding users from the details of any specific computer hardware or database implementation. Using relational techniques, the DBMS stores, manipulates and retrieves data in the form of table-like relations typically defined by a set of columns or attributes of data types and a set of rows (i.e. records or tuples) of data. The standard database query language for dealing with relational databases implemented by most commercial DBMSs is the Structured Query Language (“SQL”).

The data processing system 100 includes computer executable programmed instructions for directing the system 100 to implement the embodiments of the present invention. The programmed instructions may be embodied in one or more software modules 170 resident in the memory 130 of the data processing system 100. Alternatively, the programmed instructions may be embodied on a computer readable medium (such as a CD disk or floppy disk) which may be used for transporting the programmed instructions to the memory 130 of the data processing system 100. Alternatively, the programmed instructions may be embedded in a computer-readable, signal-bearing medium that is uploaded to a network by a vendor or supplier of the programmed instructions, and this signal-bearing medium may be downloaded to the data processing system 100 from the network by end users or potential buyers.

The CPU 120 of the system 100 is typically coupled to one or more devices 110 for receiving user commands or queries and for displaying the results of these commands or queries to the user on a display 140. For example, user queries may be transformed into a combination of SQL commands for producing one or more tables of output data which may be incorporated in one or more display pages for presentation to the user. The CPU 120 is coupled to memory 130 for containing software modules 170 and data such as base tables or virtual tables such as views or derived tables. As mentioned, the memory 130 may include a variety of storage devices including internal memory and external mass storage typically arranged in a hierarchy of storage as understood to those skilled in the art.

A user may interact with the data processing system 100 and its software modules 170 using a graphical user interface (“GUI”) 180. GUIs are supported by common operating systems, such as IBM OS/2™, and provide a display format which enables a user to choose commands, execute application programs, manage computer files, and perform other functions by selecting pictorial representations known as icons, or items from a menu through use of an input or pointing device such as a mouse 110. In general, a GUI is used to convey information to and receive commands from users and generally includes a variety of GUI objects or controls, including icons, toolbars, drop-down menus, text, dialog boxes, buttons, and the like. A user typically interacts with a GUI 180 presented on a display 140 by using an input or pointing device (e.g., a mouse) 110 to position a pointer or cursor 190 over an object 191 and by “clicking” on the object 191.

Thus, in a GUI based system, a mouse 110 typically controls the position of a cursor icon 190 that is displayed on the display screen 140. The cursor 190 is moved by moving the mouse 110 over a flat surface, such as the top of a desk, in the desired direction of movement of the cursor 190. Thus, the two-dimensional movement of the mouse 110 on the flat surface translates into a corresponding two-dimensional movement of the cursor 190 on the display screen 140. Now, a mouse 110 typically has one or more finger actuated control buttons (i.e. mouse buttons). While the mouse buttons can be used for different functions such as selecting a menu option pointed at by the cursor 190, the disclosed invention may use a single mouse button to “select” an object and to trace the movement of the cursor 190 along a desired path. Specifically, to select an object 191, the cursor 190 is first located within the extent of the object 191 on the display 140. In other words, the cursor 190 is “pointed” at the object 191. Next, the mouse button is depressed and released. That is, the mouse button is “clicked”. Selection is thus a point and click operation. To trace the movement of the cursor 190, the cursor 190 is located at the desired starting location, the mouse button is depressed to signal the CPU 120 to activate a function associated with the object 191, and the mouse 110 is moved while maintaining the button depressed. After the desired path has been traced, the mouse button is released. This procedure is often referred to as “clicking” and “dragging” (i.e. a click and drag operation). It will be understood that a predetermined key on a keyboard 110 could also be used to activate a mouse click or drag. In the following, the term “clicking” will refer to the depression of a mouse button indicating a selection by the user and the term “dragging” will refer to the subsequent motion of the mouse 110 and cursor 190 without the release of the mouse button.

Typically, a GUI based system presents application, system status, and other information to the user in “windows” appearing on the display 140. A window 192 is a more or less rectangular area within the display 140 in which a user may view an application or a document. Such a window 192 may be open, closed, displayed full screen, reduced to an icon, increased or reduced in size, or moved to different areas of the display 140. Multiple windows may be displayed simultaneously, such as: windows included within other windows, windows overlapping other windows, or windows tiled within the display area.

Within an application window 192, windows are typically displayed in a similar manner and generally follow similar conventions for the arrangement of menus, style of dialog boxes, and use of the keyboard and mouse 110. The name of an application and any associated document, and a menu bar for the application are typically displayed at the top of the application window 192 which contains the running application. In addition, additional windows or panes may also be displayed. For example, a dialog box is a window that may be displayed to request information from the user or to supply information to the user.

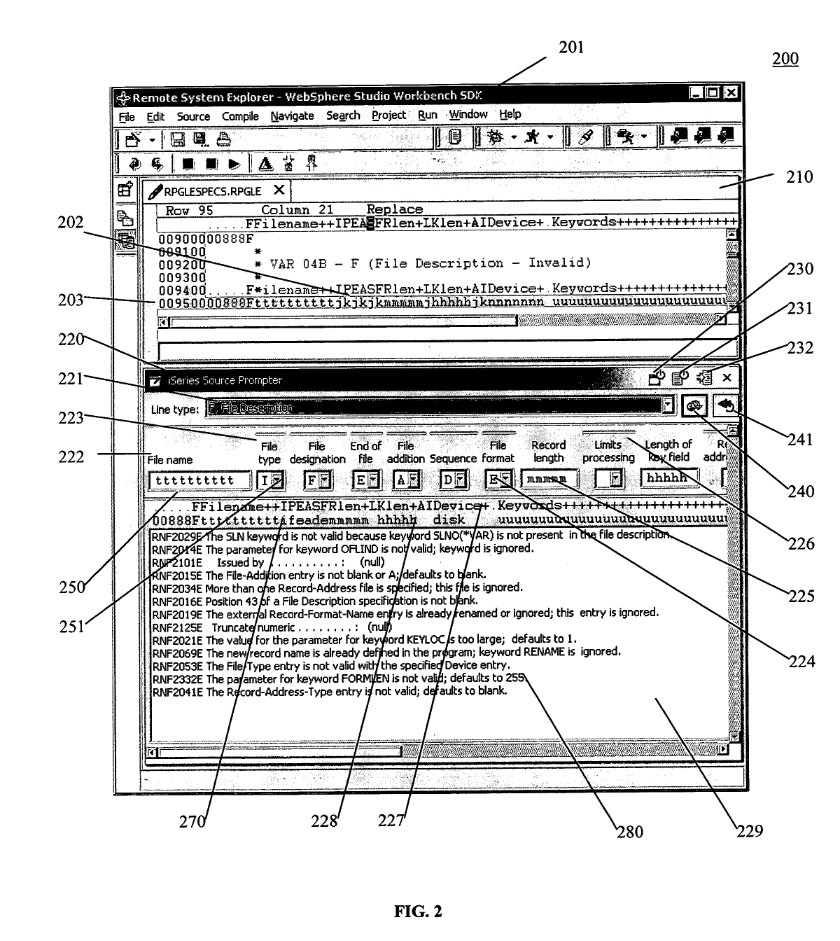

FIG. 2 is a screen capture illustrating a GUI 200 for line editing having an editor view or pane 210 and a source prompter view or pane 220 in accordance with an embodiment of the invention. The source prompter view 220 complements the editor view 210 by allowing a user to view and modify properties of a single fixed format statement. As will be described below, the data processing system 100 includes software modules 170 for implementing the following: a construct which will be referred to as a “page group” that contains metadata that describes the information about a group of viewable pages, where each page contains information about a single fixed format statement type; a source prompter view GUI 220 that complements a programming language editor having a editor view GUI 210 and that allows a user to view and modify statement scoped information; and, a programming interface that allows the source prompter 220 to communicate with the editor 210.

In the following the terms “editor” and “editor view” will be used interchangeably as will the terms “source prompter” and “source prompter view”. It will be understood that modules 170 associated with the editor and/or source prompter implement the editor view GUI 210 and/or source prompter view GUI 220, respectively.

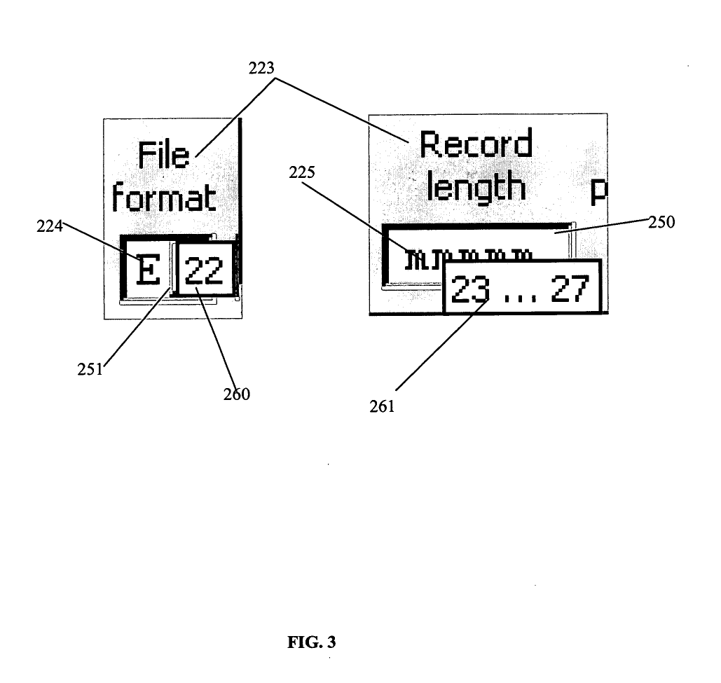

The source prompter view 220 includes the following areas: a statement type indicator and selector 221; fields 222, each having a descriptive label 223, an editable value 224, 225, a column range indicator 260, 261 (see FIG. 3), and a field difference indicator 226 which indicates whether an editable value 224, 225 is different than the corresponding value in the editor view 210; a statement format line 227; a modified statement preview line 228; and, a statement syntax check result area 229. These areas will be described in more detail below.

In FIG. 2, a programming language editor 210 is shown with a source prompter view 220 below it. In other words, the editor 210 is displayed in a pane above the pane of the source prompter view 220. Both panes 210, 220 are included in a window 200 having a title 201 (e.g., “Remote System Explorer-WebSphere Studio Workbench SDK”). The editor 210 has a cursor 202 which is located within a statement 203. The source prompter view 220 displays information pertaining to the statement 203 and allows a user to modify the statement's properties.

The source prompter view 220 also includes several toolbar buttons 230, 231, 232. These toolbar buttons allow a user to modify behaviour of the source prompter view 220. The toolbar buttons 230, 231, 232 specific to the source prompter view 220 include the following:
An enable or disable view button 230: When enabled, the source prompter view 220 responds to changes in the editor's 210 cursor position 202. When disabled, the source prompter view 220 displays an empty user interface;
An enable or disable syntax checking button 231: When enabled, syntax checking is automatically invoked. When disabled, syntax checking is not performed; and,
An insert or replace mode button 232: In insert mode, field values 224, 225 are used to compose a new statement 270, as will be described below, and the new statement 270 is inserted into the editor view 210. In replace mode, a modified statement 270 replaces the existing statement 203 in the editor view 210.

Moreover, the source prompt view 220 also includes several action buttons 240, 241. The action buttons 240, 241 allow a user to set or reset the content of the source prompter view 220. The source prompter view 220 includes the following action buttons 240, 241:
An apply button 240: This button is always visible in insert mode, and is visible in replace mode only when there are differences between the statement 203 in the editor 210 and the source prompter view's assembled statement 270. When selected, an assembled statement 270 either replaces an existing editor statement 203 or is inserted as a new statement in the editor 210 depending on the state of the insert or replace mode toolbar button 232; and,
A revert button 241: This button is visible in replace mode only when there are differences between the statement 203 in the editor 210 and the source prompter view's assembled statement 270. When selected, the field values 224, 225 in the source prompter view 220 are replaced by the editor's statement's field values 203. Prior modifications to fields 222 within the source prompter view 220 are discarded.

The areas of the source prompter view 220 introduced above will now be described in more detail.

The statement type indicator and selector 221 is a drop-down list of predefined statement types. It displays the active language specific statement type and allows a user to select a different statement type from the drop-down list. Whenever “help” is requested, such as by pressing the F1 key on a keyboard input device 110, help information pertaining to the selected statement type is displayed. The help information may be displayed in a pop-up window or dialog box, for example.

With respect to the fields 222, a set of entry widgets, each one representing a field of a statement, is presented in field column order. Each entry widget can be one of the following: an editable text widget 250; a editable drop-down widget 251, or a non-editable drop-down widget (not shown). Whenever an entry widget 250, 251 is selected, and help is requested, such as through an F1 key press, help information is displayed for the field type.

With respect to creating an entry widget 250, 251, a text widget 250 is created if the field 222 has no associated choices. Otherwise, if there are choices, then a drop-down widget 251 is created. For drop-down widgets 251, the editable option, if present, determines whether the drop-down is editable such that a user may enter a value 224 that is not one of the predefined choices.

Above each entry field widget 250, 251 is a label widget 223 which displays the descriptive name of the field.

Above each label widget 223 is a difference indicator widget 226 which is only visible when the field value 224, 225 in the source prompter view 220 is different than that of the field in the statement 203 in the editor 210.

FIG. 3 is a partial screen capture illustrating hover text 260, 261 for the source prompter view 220 of FIG. 2 in accordance with an embodiment of the invention. Each label widget 223 and each entry widget 250, 251 displays hover text 260, 261, also known as fly-over text, which displays the column range of the field. If a field occupies a single column, then a single number, such as “22” 260, is displayed. Otherwise, the beginning column number and the end column number separated by three periods, such as “23 . . . 27” 261, is displayed.

The format line 227 is predefined text which describes the meaning of a statement type's columns. It consists of a string of characters, one character for each statement column. The string is divided into field descriptors, where each field descriptor indicates the function of the field.

As mentioned above, the invention implements a page group construct. A page group contains information required by the source prompter view 220 in order to display an appropriate user interface for each programming language (e.g., DDS, etc.). Page group information may be defined in a document such as an Extensible Markup Language (“XML”) document, for example. This document may be stored in the database system 160.

As is known, XML is a flexible way to create common information formats and share both the format and the data on the Web and other networks. XML is a formal recommendation from the World Wide Web Consortium (“W3C”) and is similar to the Hypertext Markup Language (“HTML”). An XML document can be processed purely as data by a program, it can be stored, or it can be displayed like an HTML document. Thus, XML is “extensible” because, unlike HTML, the markup symbols are unlimited and self-defining. In addition, XML markup may appear within an HTML page.

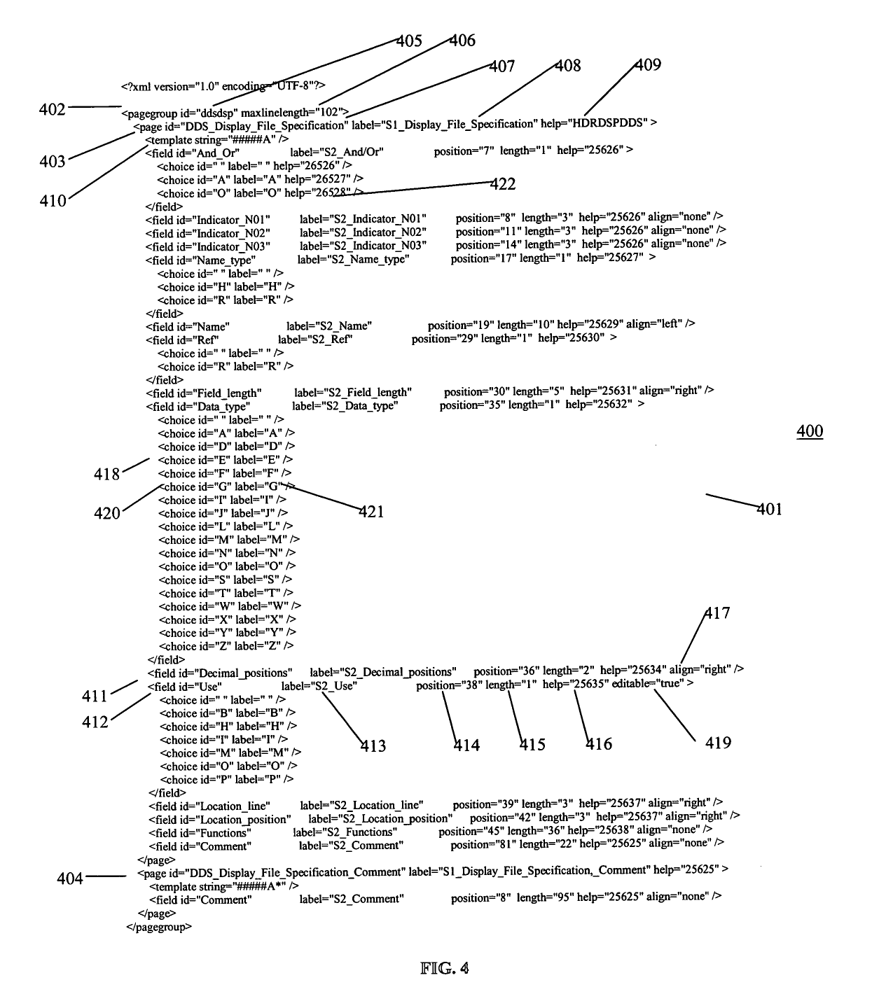

FIG. 4 is an exemplary XML document 400 illustrating page group information 401 in accordance with an embodiment of the invention. This example contains one page group 402 that contains two pages 403, 404. Each page 403, 404 represents a statement type.

A page group 402 includes the following information: an identifier 405 (e.g., “ddsdsp”), a maximum statement character length 406 (e.g., “102”), and a set of pages 403, 404.

Each page 403, 404 includes the following information pertaining to one statement type: a page identifier 407 (e.g., “DDS_Display_File_Specification”); a specification label 408, which is a key to a national language translated text string (e.g., “S1_Display_File_Specification”); a specification help identifier 409 (e.g., “HDRDSPDDS”); a specification template string 410 (e.g., “#####A”), which will be described in more detail below; and, a set of field descriptions 411.

Each field description 411 includes the following information: a field identifier 412 (e.g., “Use”); a field label 413 (e.g. “S2_Use”), which is a key to a national language translated text string; a field position 414 (e.g., “38”); a field length 415 (e.g., “1”); an optional field help identifier 416 (e.g., “25635”); an optional field alignment option 417 (e.g., “right”); an optional set of choices 418; and, an optional editable option 419 (e.g., “true”) for choice fields which indicates whether a value can be specified that is not one of the defined choices.

Each choice 418 includes the following information: a choice identifier 420 (e.g., “G”); a choice label 421 (e.g., “G”), which is national language independent; and, an optional help identifier 422 (e.g., “26528”).

Referring again to FIG. 2, the statement preview line 228 displays an assembled statement 270, assembled from the values 224, 225 of the individual field widgets 250, 251, and reflects what the statement would be before being set in the editor 210. Whenever a field 222 is modified, the content of each field 224, 225 is justified within the field according to the field's alignment property 417. All field values 224, 225 are then combined to form the assembled statement 270 displayed on the statement preview line 228.

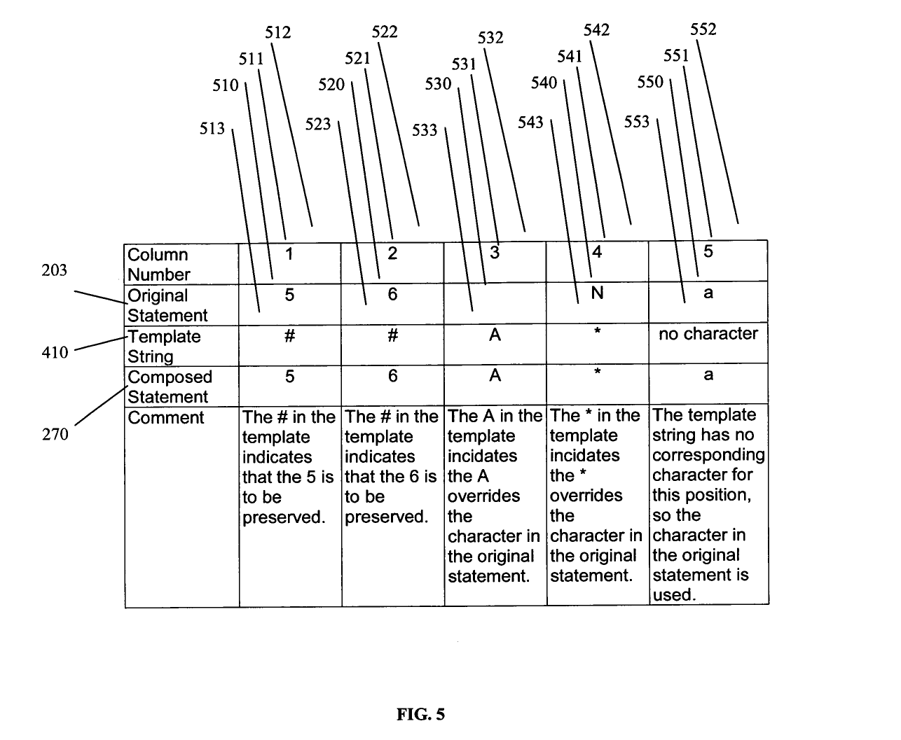

FIG. 5 is a chart illustrating the composition of a new statement 270 from an original statement 203 and a template string 410 in accordance with an embodiment of the invention. The template string 410 is a string of characters 510, 520, 530, 540, 550 used to determine how a statement 270 is to be assembled with respect to the following: character positions not occupied by one of the editable fields; and, editable field value characters. The template string 410 is used when a statement 270 is being assembled from prompter view field widget values 224, 225.

The first character 510 of the template string 410 corresponds to the first character 511 of the original statement 203, the second character 520 of the template string 410 corresponds to the second character 521 of the original statement 203, and so on. The template string 410 may be shorter than the full length of a statement 203. As shown in FIGS. 4 and 5, a sample template string 410 may be “#####A*” or “##A*_”, respectively. In the template string 410, the # symbol 510, 520 indicates that the character in the # symbol's column position 512, 522 of the original statement 203, 511, 521 is to be preserved in any new statement 270, 513, 523; any other character (e.g., A 530, * 540) indicates that the character 530, 540 is to replace any character 531, 541 in the column position 532, 542 of the original statement 203 in the new statement 270, 533, 543; and, any character 551 whose position is not represented (i.e., “no character” 550 in column 5 552) in the template string 410 is preserved in the assembled string 270, 553.

The following process is used to assemble a new statement 270 from the field entry widgets 224, 225, the original statement 203, and the template string 410: (a) an empty string the length of the page group's 420 maximum statement character length (“maxlinelength”) 406 is created; for each # character 510, 520 in the template string 410, the corresponding character 511, 521 in the original string 203 is copied to the new string 270, 513, 523; for each other character 530, 540 in the template string 410, the character is copied into the new string 270; and, for each field 222, the field value 224, 225 is adjusted and then placed into the new string 270 at the location specified by the field location 414. If the field 222 is represented by a text widget 250, or an editable drop-down widget 251, the text 224, 225 is retrieved, justified, and placed in the new string 270. If the field 222 is represented by a non-editable drop-down, the selection 224, 225 is retrieved and justified. The selection is also lower cased if the original value is lower case and a preserve lower case option has been specified by the editor 210. The result is placed in the new string 270.

The following justification options 417 are available for the above process: none, no justification is performed; left, the text is left justified; right, the text is right justified; and, both, the text is left justified if the field value is alphanumeric and the text is right justified if the field is numeric.

Referring again to FIG. 2, the statement syntax check result area 229 displays a list or set of text messages 280 obtained from performing a syntax check on the statement 270. The content 280 of the check result list 229 is updated whenever a modification is made to one of the fields 222. Each message 280 is selectable. Whenever a message 280 is selected, and help is requested, such as through an F1 key press, help pertaining to the message 280 is displayed.

Modules 170 within the data processing system 100 allow the source prompter view 220 to operate in various modes. Operations within these modes are described in the following.

In “replace mode”, as selected by the insert/replace mode button 232, whenever the editor's cursor 202 moves to a new statement 203, the following operations are performed: the line type selector 221 displays the statement's type; fields 222 and field labels 223 are displayed according to the statement type; field difference indicators 226 are displayed for fields that are different from those in the editor's statement 203; the format line 227 is displayed according to the statement type; the statement preview 228 is composed and displayed; if the syntax check toolbar toggle button 231 is on, a syntax check of the statement is performed, and the results are displayed in syntax check result area 229; and, the apply and revert buttons 240, 241 are displayed if there are differences between the statement 270 in the prompter view 220 and the statement 203 in the editor 210.

In replace mode, whenever a field 222 is modified, the following operations are performed: the field's difference indicator 226 is displayed if the field is different to the corresponding field in the editor's version of the statement 203; a new statement 270 is composed and displayed on the statement preview line 228; if the syntax check toolbar toggle button 231 is on, a syntax check of the statement 270 is performed, and the results are displayed in the syntax check result area 229; and, the apply and revert buttons 240, 241 are displayed if there are differences between the modified statement 270 in the prompter view 220, and the original statement 203 in the editor 210.

In replace mode, whenever the apply button 240 is pressed, the following operations are performed: a new statement 270 is composed from the field values 224, 225 and the original statement 203 in the editor 210 is replaced with the new statement 270; the statement preview and syntax check areas 228, 229 are updated; and, the apply and revert buttons 240, 241 are hidden.

In replace mode, whenever the revert button 241 is pressed, any changes made by the user are discarded, and the prompter view 220 is updated using the contents of the editor's original statement 203.

In “insert mode”, as selected by the insert/replace mode button 232, whenever the editor's cursor 202 moves to a new statement 203, no operations are performed.

In insert mode, whenever a field 222 within the source prompter view 220 is modified, the following operations are performed: a new statement 270 is composed and displayed on the statement preview line 228; a syntax check of the statement 270 is performed, and the results are displayed in syntax check result area 229; the apply button 240 is displayed; and, the revert button 241 remains hidden.

In insert mode, whenever the apply button 240 is pressed, the following operations are performed: the new statement 270 is composed from the field values 224, 225, and is inserted into the editor 210 following the statement 203 that the cursor 202 is currently positioned on; and, the statement preview and syntax check areas 228, 229 are updated.

Upon a mode switch from insert mode to replace mode, that is, whenever the insert/replace mode button 232 is toggled to replace mode, the following operation is performed: replace mode operations (as described above) are performed using the current statement 203 as if the cursor 202 just moved to the current statement 203.

Upon a mode switch from replace mode to insert mode, that is, whenever the insert/replace mode button 232 is toggled to insert mode, the following operations are performed: all field editable values 224, 225 are cleared; and, the syntax check results area 229 is cleared.

Modules 170 (e.g., interface methods) within the data processing system 100 allow the editor 210 to communicate with the source prompter view 220. These modules and their operations are as follows:
“addPromptChangeListener” asks the editor 210 to add a listener, which is notified whenever the editor cursor 202 moves to a different statement 203;
“displayHelp” displays the help message for a string identifier;
“displayMessageHelp” asks the editor 210 to display the help message for a syntax error message identifier;
“getPromptFont” asks the editor 210 for the font which is used to display the field values 224, 225, statement preview line 228, and format line 227;
“getPromptFormatLine” asks the editor 210 for the format line 203 for a given statement type;
“getPromptMaxLineLength” asks the editor 210 for the maximum length of the statement;
“getPromptGroup” asks the editor 210 for the information required to display all of a language's statement types;
“getPromptPageIndex” asks the editor 210 for the index into the prompt group for a given statement number;
“getRetainLowerCase”: Multiple choice fields represented by a drop-down widget may display choices only in upper case. However, a user may have typed in the value of the field in lower case. This method asks the editor 210 whether the field 222 should retain its lower case characters if the current field value 224, 225 is in lower case;
“getSyntaxChecker” asks the editor 210 for a syntax checker. The syntax checker is called by the prompter view 220 to perform a syntax check. The prompter view then displays its results in the syntax check area 229;
“promptLineChanged” notifies the editor 210 that the source prompter view 220 has either a programming statement that has been edited, in which case the original statement is to be replaced with the edited statement, or a new statement to be inserted after the statement in the editor in which the cursor resides;
“removePromptChangeListener” asks the editor 210 to remove the previously added listener; and,
“setInsertModeAction” gives the editor 210 the action which the editor can query to determine whether a statement received during a “promptLineChanged” operation should be inserted or replaced.

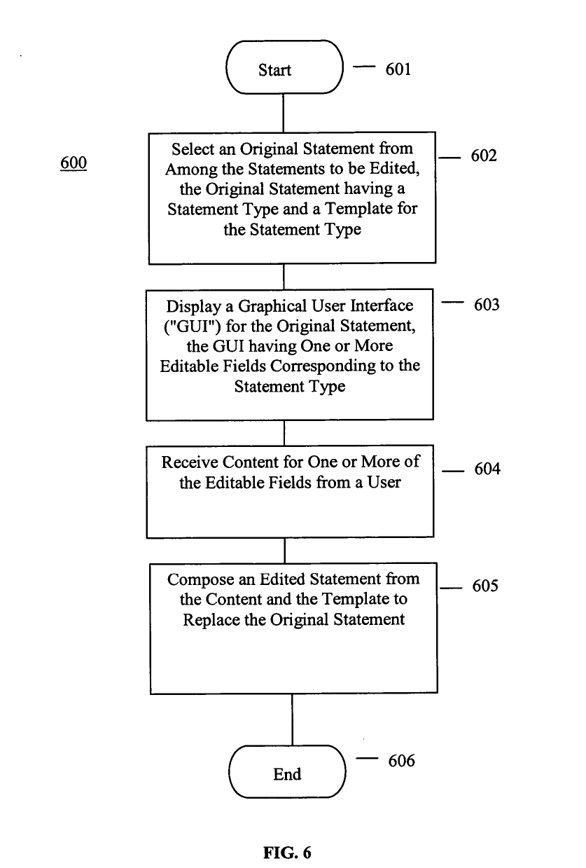

FIG. 6 is a flow chart illustrating operations 600 of modules 170 within a data processing system 100 for editing column oriented programming language statements 210 presented to a user on a computer display screen 140 in accordance with an embodiment of the invention.

At step 601, the operations 600 start.

At step 602, an original statement 203 is selected from among the statements 210, the original statement 203 having a statement type and a template 410 for the statement type. Preferably, the selecting is performed by the user by positioning a cursor 202 on an editor GUI 210 with a pointing device 110.

At step 603, a graphical user interface (“GUI”) 220 is displayed for the original statement 203, the GUI 220 having one or more editable fields 222 corresponding to the statement type.

At step 604, content 224, 225 is received for one or more of the editable fields 222 from a user. Preferably, the operations also include the steps of: accessing a predetermined document 400 containing the template 410 and one or more content choices 420 for one or more of the editable fields 222; displaying one or more of the content choices 420 to the user through the GUI 220; and, displaying a field difference indicator 226 on the GUI 220 for each of the editable fields 222 whose contents 224, 225 differs from a corresponding field in the original statement 203. And, preferably, the document 400 is an extensible mark-up language (“XML”) document.

At step 605, an edited statement 270 is composed from the content 224, 225 and the template 410 to replace the original statement 203. Preferably, the operations also include the step of selectively replacing the original statement 203 with the edited statement 270, wherein the selectively replacing includes displaying a user selectable apply button 240 on the GUI 220 when the edited statement 270 differs from the original statement 203.

At step 606, operations 600 end.

While this invention is primarily discussed as a method, a person of ordinary skill in the art understands that the apparatus discussed above with reference to a data processing system may be programmed to enable the practice of the method of the invention. Moreover, an article of manufacture for use with a data processing system, such as a pre-recorded storage device or other similar computer readable medium including program instructions recorded thereon may direct the data processing system to facilitate the practice of the method of the invention. It is understood that such apparatus and articles of manufacture also come within the scope of the invention.

The embodiment(s) of the invention described above is(are) intended to be exemplary only. The scope of the invention is therefore intended to be limited solely by the scope of the appended claims.

1. For a program statement editor, a method for editing column oriented programming language statements presented to a user on a display screen, comprising:
providing a template description defining one or more statement types; and,
providing a graphical user interface (“GUI”) for editing said statements individually, said GUI having one or more editable fields corresponding to a statement type of an individual statement defined by said template description, said GUI adapted to receive content for one or more of said editable fields from said user to define said individual statement.

2. The method of claim 1 and further comprising permitting said individual statement to be selected by said user for replacement from among said statements.

3. The method of claim 2 and further comprising permitting a position in said statements to be selected by said user for insertion of said individual statement.

4. The method of claim 3 and further comprising displaying a field difference indicator on said GUI for each of said editable fields whose contents has been changed by said user.

5. The method of claim 4 and further comprising one of selectively replacing and inserting said individual statement in said statements.

6. The method of claim 5 and further comprising displaying a user selectable apply button on said GUI for initiating said replacing and inserting.

7. The method of claim 1 wherein said template description is an extensible mark-up language (“XML”) document.

8. A system for editing column oriented programming language statements, said system having a display and an input device for editing said statements through an editor graphical user interface (“GUI”), said system comprising:
a processor coupled to said display and said input device and adapted for: providing a template description defining one or more statement types; and, providing a prompter GUI for editing said statements individually, said prompter GUI having one or more editable fields corresponding to a statement type of an individual statement defined by said template description, said prompter GUI adapted to receive content for one or more of said editable fields from said user to define said individual statement.

9. The system of claim 8 and further comprising said processor adapted for permitting said individual statement to be selected by said user for replacement from among said statements.

10. The system of claim 9 and further comprising said processor adapted for permitting a position in said statements to be selected by said user for insertion of said individual statement.

11. The system of claim 10 and further comprising said processor adapted for displaying a field difference indicator on said prompter GUI for each of said editable fields whose contents has been changed by said user.

12. The system of claim 11 and further comprising said processor adapted for one of selectively replacing and inserting said individual statement in said statements.

13. The system of claim 12 and further comprising said processor adapted for displaying a user selectable apply button on said prompter GUI for initiating said replacing and inserting.

14. The system of claim 8 wherein said template description is an extensible mark-up language (“XML”) document.

15. A computer program product having a computer readable medium tangibly embodying computer executable code for directing a data processing system to edit column oriented programming language statements presented to a user on a display screen, said computer program product comprising:
code for providing a template description defining one or more statement types; and,
code for providing a graphical user interface (“GUI”) for editing said statements individually, said GUI having one or more editable fields corresponding to a statement type of an individual statement defined by said template description, said GUI adapted to receive content for one or more of said editable fields from said user to define said individual statement.

16. The computer program product of claim 15 and further comprising code for permitting said individual statement to be selected by said user for replacement from among said statements.

17. The computer program product of claim 16 and further comprising code for permitting a position in said statements to be selected by said user for insertion of said individual statement.

18. The computer program product of claim 17 and further comprising code for displaying a field difference indicator on said GUI for each of said editable fields whose contents has been changed by said user.

19. The computer program product of claim 18 and further comprising code for one of selectively replacing and inserting said individual statement in said statements.

20. The computer program product of claim 19 and further comprising code for displaying a user selectable apply button on said GUI for initiating said replacing and inserting.

21. The computer program product of claim 15 wherein said template description is an extensible mark-up language (“XML”) document.

22. An article having a computer readable modulated carrier signal being usable over a network, and having means embedded in the computer readable modulated carrier signal for directing a data processing system to edit column oriented programming language statements presented to a user on a display screen, said article comprising:
means in the medium for providing a template description defining one or more statement types; and,
means in the medium for providing a graphical user interface (“GUI”) for editing said statements individually, said GUI having one or more editable fields corresponding to a statement type of an individual statement defined by said template description, said GUI adapted to receive content for one or more of said editable fields from said user to define said individual statement.

23. The article of claim 22 and further comprising means in the medium for permitting said individual statement to be selected by said user for replacement from among said statements.

24. The article of claim 23 and further comprising means in the medium for permitting a position in said statements to be selected by said user for insertion of said individual statement.

25. The article of claim 24 and further comprising means in the medium for displaying a field difference indicator on said GUI for each of said editable fields whose contents has been changed by said user.

26. The article of claim 25 and further comprising means in the medium for one of selectively replacing and inserting said individual statement in said statements.

27. The article of claim 26 and further comprising means in the medium for displaying a user selectable apply button on said GUI for initiating said replacing and inserting.

28. The article of claim 22 wherein said template description is an extensible mark-up language (“XML”) document.
